(19) United States
(12) Patent Application Publication
(10) Pub. No.: US 2025/0192303 A1
(43) Pub. Date: Jun. 12, 2025

(54) VEHICLE BASE STRUCTURE

(71) Applicant: TOYOTA JIDOSHA KABUSHIKI KAISHA, Aichi-ken (JP)

(72) Inventors: Yoshinori DOMON, Nagoya-shi (JP); Masahiro IIDA, Okazaki-shi (JP); Kouhei KURIYAMA, Nagoya-shi (JP)

(21) Appl. No.: 18/966,134

(22) Filed: Dec. 3, 2024

(30) Foreign Application Priority Data
Dec. 12, 2023 (JP) 2023-209124

(51) Int. Cl. H01M 50/24; B60L 50/60; H01M 50/249; H01M 50/271

(52) U.S. Cl. CPC H01M 50/24; B60L 50/66; H01M 50/249; H01M 50/271; H01M 2220/20

(57) ABSTRACT

A vehicle base structure applicable to a vehicle with a battery mounted under a floor of the vehicle is provided. The vehicle base structure includes an under cover which is disposed below the battery and forms at least a portion of a bottom of the vehicle. The under cover includes a front cover and a rear cover disposed at a rearward position relative to the front cover in a longitudinal direction of the vehicle. A connection portion is provided. The connection portion is an overlap between a rear end of the front cover and a front end of the rear cover. One of the front cover and the rear cover that is located above the other of the front cover and the rear cover at the connection portion has a protrusion protruding downward from the vehicle at a position adjacent to the connection portion.

### CROSS REFERENCE TO RELATED APPLICATION

This application claims priority to Japanese Patent Application No. 2023-209124 filed on Dec. 12, 2023, which is incorporated herein by reference in its entirety including the specification, claims, drawings, and abstract.

### TECHNICAL FIELD

This disclosure relates to a vehicle base structure, and in particular to a vehicle base structure applicable to a vehicle with a battery mounted under a floor of the vehicle.

### BACKGROUND

Electrically powered vehicles such as Battery Electric Vehicle (BEV), Hybrid Electric Vehicle (HEV), and Plug-in Hybrid Electric Vehicle (PHEV) are well known. The electrically powered vehicle include a battery that supplies power to a drive motor. The battery is mounted under a floor of the vehicle. An under cover is disposed below the battery. The under cover forms at least a portion of a bottom of the vehicle.

Patent Literature 1 (JP 2011-219042 A) discloses the under-floor structure of an electrically powered vehicle, in which a battery unit installed under a floor of the vehicle is covered by a battery under cover.

### CITATION LIST

### Patent Literature

PATENT LITERATURE 1: JP 2011-219042 A

### SUMMARY

An under cover may consist of multiple covers. The under cover includes a front cover and a rear cover disposed at a rearward position relative to the front cover in a longitudinal direction of a vehicle. A connection portion being an overlap between a rear end of the front cover and a front end of the rear cover is provided.

In a vehicle that includes the under cover like this, there is a risk that snow will enter an inside of the vehicle from the overlap (the connection portion) between the front cover and rear cover when the vehicle is driven on a road with snow. Therefore, a vehicle base structure that can prevent snow from entering through the overlap (the connection portion) between the two covers is desired.

An object of the present disclosure is to provide a vehicle base structure that can prevent snow from entering through the connection portion of the two covers on a bottom of a vehicle.

A vehicle base structure according to the present disclosure is applicable to a vehicle with a battery mounted under a floor of the vehicle is provided. The vehicle base structure includes an under cover which is disposed below the battery and forms at least a portion of a bottom of the vehicle. The under cover includes a front cover and a rear cover disposed at a rearward position relative to the front cover in a longitudinal direction of the vehicle. A connection portion is provided. The connection portion is an overlap between a rear end of the front cover and a front end of the rear cover. One of the front cover and the rear cover that is located above the other of the front cover and the rear cover at the connection portion has a protrusion protruding downward from the vehicle at a position adjacent to the connection portion.

In the vehicle base structure according to the present disclosure, the front end of the rear cover may be located above the rear end of the front cover in the connection portion, and the rear cover may have the protrusion at a rearward position relative to the connection portion in the longitudinal direction of the vehicle.

In the vehicle base structure according to the present disclosure, a distance in the vertical direction of the vehicle from a bottom surface of the rear cover at a front end thereof to a bottom surface of the protrusion of the rear cover at an apex thereof may be defined as a height of the protrusion. A distance in the longitudinal direction of the vehicle from the apex of the protrusion of the rear cover to a rearward end of change in height of the bottom surface of the rear cover may be defined as a return distance of the protrusion. The return distance of the protrusion may be twice the height of the protrusion.

In the vehicle base structure according to the present disclosure, the rear end of the front cover may be located above the front end of the rear cover in the connection portion. The front cover may have the protrusion at a frontward position relative to the connection portion in the longitudinal direction of the vehicle.

According to the present disclosure, as the vehicle moves, accumulated snow moves toward the vehicle in a direction. The direction is from one of the front cover and the rear cover that is located above the other of them at the connection portion to the other of them. At that time, the protrusion pushes the snow down, and it is possible to prevent the snow from advancing to the edge (the end face) of the lower cover that appears on the bottom of the vehicle. This prevents snow from entering the vehicle through the overlap (the connection portion) of the two covers.

### BRIEF DESCRIPTION OF DRAWINGS

Embodiments of the present disclosure will be described based on the following figures, wherein:

FIG. 1 is a cross-sectional view schematically showing a vehicle base structure.

FIG. 2 is a bottom view schematically showing a bottom of a vehicle.

FIG. 3 is an enlarged cross-sectional view of a connection portion of an under cover.

FIG. 4 is an enlarged cross-sectional view of a modification of a connection portion of an under cover.

FIG. 5 is a cross-sectional view schematically showing comparative technology of a vehicle base structure.

### DESCRIPTION OF EMBODIMENTS

The embodiments of the present disclosure are described below based on the drawings. The present disclosure is not limited to the embodiments described herein. In all drawings, identical elements are marked with the same symbol and redundant explanations are omitted. In the following description, unless otherwise specified, the terms indicating the front-rear, right-left, and up-down, etc. directions indicate the directions related to a vehicle. In each figure, the direction of the arrow FR indicates a forward direction, the direction of the arrow UP indicates an upward direction, and the direction of the arrow RH indicates a rightward direction.

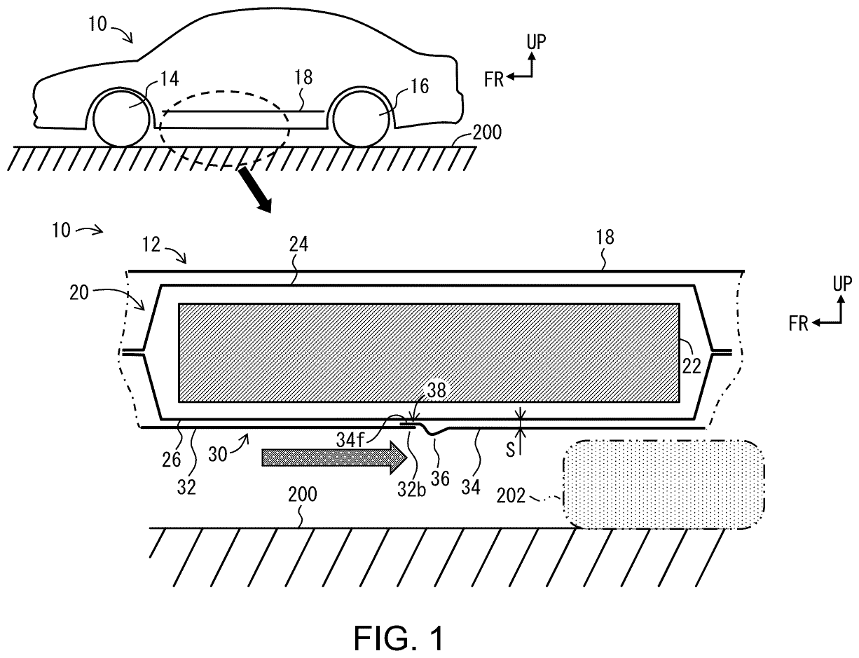

FIG. 1 is a cross-sectional view schematically showing a vehicle base structure 12, the entire vehicle 10 is schematically shown above. The lower part of FIG. 1 shows an enlarged cross-sectional view of the area enclosed by the broken line in the upper part of FIG. 1 (the area below the vehicle between the front wheel 14 and the rear wheel 16). The lower part of FIG. 1 shows the vehicle base structure 12. FIG. 1 also shows a ground 200 and an accumulated snow 202.

Vehicle 10 is a Plug-in Hybrid Electric Vehicle (PHEV) and is an automobile. Vehicle 10 may also be another electrically powered vehicle, such as a Battery Electric Vehicle (BEV) or a Hybrid Electric Vehicle (HEV). A battery 20 is mounted under a floor of the vehicle 10. In other words, the battery 20 is located beneath a vehicle's floor panel 18. The upper side of the floor panel 18 is a vehicle compartment.

The battery 20 includes a battery body 22, an upper case 24, and a lower case 26. The battery body 22 includes multiple battery cells. The battery body 22 supplies power to a drive motor (not shown) that drives the vehicle 10 and to an air conditioner, etc. The battery body 22 is charged by external power or regenerative power generated when the vehicle 10 is decelerating. The upper case 24 covers an upper part of the battery body 22. The lower case 26 covers a lower part of the battery body 22. The upper case 24 and the lower case 26 are joined together, and the battery body 22 is placed inside them. The battery 20 can also be referred to as a battery unit or a battery pack.

The vehicle 10 includes an under cover 30. The under cover 30 is disposed below the battery 20. The under cover 30 forms a portion of a bottom of the vehicle. The under cover 30 includes a front cover 32 and a rear cover 34 disposed at a rearward position relative to the front cover 32. The connection portion 38 of the covers 32, 34 is formed by overlapping a rear end 32b of the front cover 32 and a front end 34f of the rear cover 34.

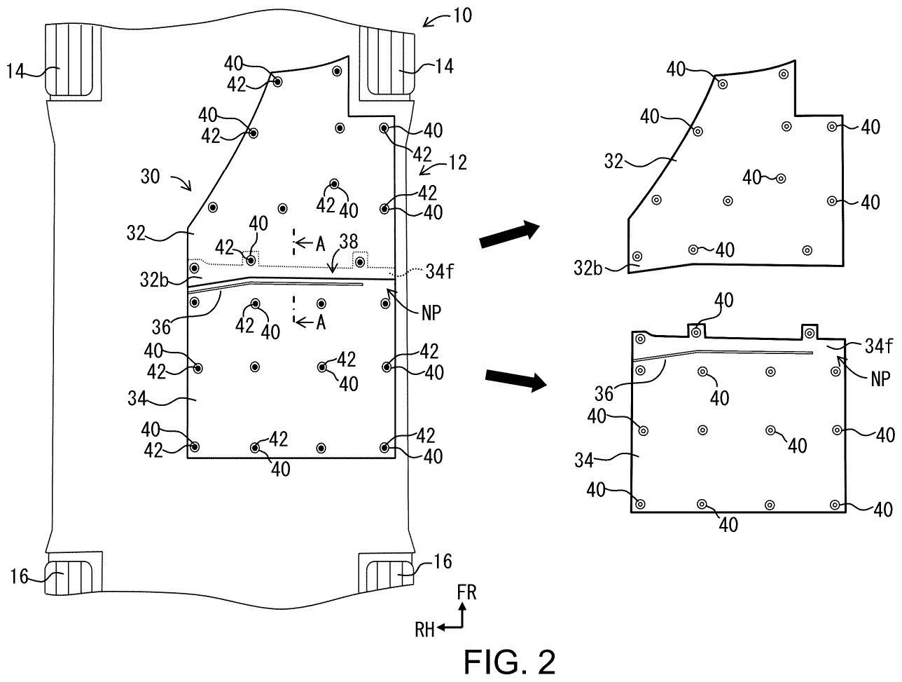

FIG. 2 is a bottom view schematically showing a bottom of the vehicle 10. In the right part of FIG. 2, the front cover 32 and the rear cover 34 removed from the vehicle 10 are shown. In FIG. 2, components that are not closely related to the embodiment have been omitted. For example, at the bottom of the vehicle 10, on the right side of the under cover 30 (left side in FIG. 2), there is a tunnel section that contains an exhaust pipe through which exhaust gas emitted from an engine flows.

The under cover 30 extends from an area close to the front wheel 14 to an area in front of the rear wheel 16, and is positioned close to the left side of the vehicle (right side of FIG. 2). The under cover 30 is divided into two parts in the front-back direction, and is composed of the front cover 32 and the rear cover 34. The battery 20 is located above the under cover 30.

The front cover 32 and the rear cover 34 are made of a resin plate. The rear end 32b of the front cover 32 is slightly wider than half the width of the vehicle. The front cover 32 has a narrower shape at the front than at the back. The rear cover 34 is slightly wider than half the width of the vehicle. The rear cover 34 is roughly rectangular in shape.

The front cover 32 and the rear cover 34 each include multiple joints 40 for connecting to the lower case 26 of the battery 20 (see FIG. 1). In FIG. 2, only some of the multiple joints 40 are marked with the symbol 40. The joint 40 includes a circular recess and a through-hole in the center of the recess, as seen from the bottom of the vehicle. The lower case 26 of the battery 20 includes a hole (not shown) in a position opposite the through-hole of the joint 40 of the front cover 32 and the rear cover 34 (hereinafter referred to as the covers 32, 34).

Clips 42 are used to connect the cover 32, 34 and the lower case 26. The clip 42 is pushed from the bottom side of the vehicle 10 through the through-hole of the joint 40 and the hole of the lower case 26, and the tip of the clip 42 (the legs that expand when the clip 42 is pushed in) are engaged with the upper surface around the hole of the lower case 26, thereby joining the cover 32 (or the cover 34) to the lower case 26. In FIG. 2, the heads of the clips 42 that appear on the bottom of the vehicle are indicated by black dots.

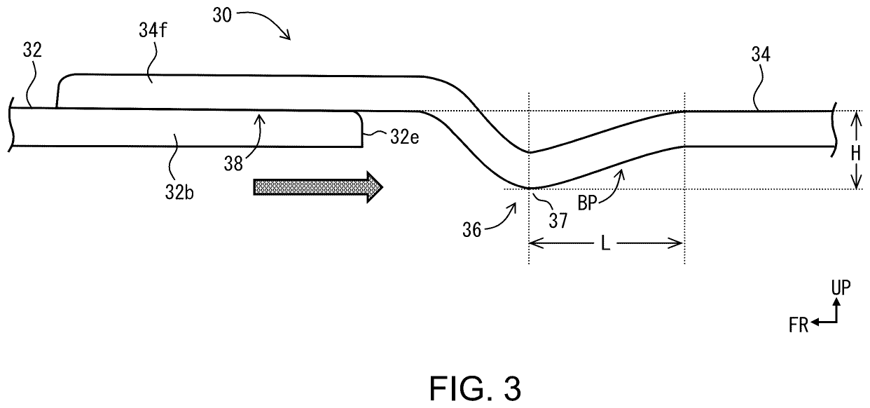

FIG. 3 is a cross-sectional view along the A-A line in FIG. 2, and shows the cross-section of the connection portion 38 between the front cover 32 and the rear cover 34. The front end 34f of the rear cover 34 overlaps an upper surface of the rear end 32b of the front cover 32. As shown in FIG. 2, each of the two covers 32, 34 has multiple joints 40 in this overlapping portion (the connection portion 38). FIG. 2 shows a configuration in which each of the two covers 32, 34 has three joints 40 in the overlapping portion. In the overlapping portion, the through-hole of the joint 40 of the front cover 32 and the through-hole of the joint 40 of the rear cover 34 are aligned, and a clip 42 is passed through these two through-holes and engaged with a hole in the lower case 26.

The rear cover 34 has a protrusion 36 (see FIG. 3) that protrudes downward from the vehicle and is located adjacent to the overlapping portion (the connection portion 38). The protrusion 36 is also referred to as a bead. The protrusion 36 is provided at a rearward position relative to the connection portion 38. The protrusion 36 is provided along the rear end surface 32e of the front cover 32 (see FIG. 3) that appears on the bottom surface of the vehicle.

Here, referring to FIG. 3, a height H of the protrusion 36 and a return distance L of the protrusion 36 are defined. The height H of the protrusion 36 is a distance in the vertical direction of the vehicle from a bottom surface of the rear cover 34 at the front end 34f thereof to a bottom surface of the protrusion 36 of the rear cover 34 at an apex 37 thereof. The return distance L of the protrusion 36 is a distance in the longitudinal direction of the vehicle from the apex 37 of the protrusion 36 of the rear cover 34 to a rearward end of change in height of the bottom surface of the rear cover 34.

In this embodiment, the ratio of the height H and the return distance L of the protrusion 36 is 1:2 (H:L=1:2). In other words, the return distance L of the protrusion 36 is twice the height H of the protrusion 36.

Next, the effects of the vehicle base structure 12 described above are explained.

When the vehicle 10 is driving backward on the road with accumulated snow 202 (see FIG. 1), the accumulated snow 202 advances toward the end face 32e (see FIG. 3) of the lower cover (the front cover 32) of the connection portion 38 that appears on the bottom of the vehicle 10. In this situation, there is a risk that the snow will enter the vehicle interior via the connection portion 38 (the overlapping portion).

However, according to the embodiment described above, when the snow 202 advances toward the end face 32e of the front cover 32, the protrusion 36 pushes the snow 202 down, and prevents the snow 202 from advancing toward the end face 32e of the front cover 32. As a result, it is possible to prevent the snow from entering the vehicle interior through the connection portion 38 between the two covers 32, 34. It is possible to prevent the snow from entering through the connection portion 38, accumulating on the upper surface of the front cover 32, and damaging the under cover 30 due to the weight of the snow.

In the embodiment described above, as shown in FIG. 2, the connection portion 38 at a rear of the front wheel 14 and a front of the rear wheel 16 do not have the protrusion 36. In other words, the area indicated by the symbol NP in FIG. 2 does not have any protrusion. This is because when the vehicle 10 is driving on a snow-covered road, the wheels 14, 16 tread on the snow, so there is a high probability that the snow will not approach the connection portion 38 located between the wheels 14, 16, and the risk of the snow entering that portion is low. In this way, by minimizing the protrusion 36, it is possible to suppress the deterioration of the aerodynamic performance of the vehicle 10 due to the protrusion 36. In this embodiment, the protrusion 36 for the connection portion 38 located between the wheels 14, 16 has been omitted, but it is also possible to have a structure that includes the protrusion 36 for the connection portion 38 located between the wheels 14, 16.

In addition, according to the embodiment described above, as shown in FIG. 3, the height H of the protrusion 36 and the return distance L of the protrusion 36 are in a 1:2 ratio. This ratio of H and Lis set in consideration of the balance between the aerodynamic performance and ground clearance of the vehicle 10.

Here, consider the case where L is very large compared to H, i.e., a rear lower surface BP (see FIG. 3) of the protrusion 36 has a very gentle slope. In this case, when the vehicle 10 is traveling forward and air (see the bold arrows in FIGS. 1 and 3) flows over the protrusion 36, the air flows more easily along the rear lower surface BP of the protrusion 36, which improves the aerodynamic performance of the vehicle 10. On the other hand, in this case, the rear lower surface BP of the protrusion 36 is at a low position over a relatively long distance (length), which is a disadvantage from the perspective of ensuring the ground clearance of the vehicle 10.

Next, consider the case where H is very large compared to L, i.e., the rear lower surface BP (see FIG. 3) of the protrusion 36 has a very steep slope. In this case, when the vehicle 10 is moving forward and air (see the bold arrows in FIGS. 1 and 3) flows over the protrusion 36, a vortex is generated on the rear lower surface BP of the protrusion 36, which causes a problem in that the aerodynamic performance of the vehicle 10 deteriorates. On the other hand, in this case, the rear lower surface BP of the protrusion 36 is at a lower position for a relatively short distance (length), and the rear part is at a higher position, so there is the advantage of being able to secure a larger area with a higher ground clearance. (This is an advantage from the perspective of securing the ground clearance of the vehicle 10.)

According to the embodiment described above, setting H:L=1:2 allows for an appropriate balance between the aerodynamic performance and the ground clearance. In other words, the H:L ratio allows air to flow along the rear lower surface BP of the protrusion 36, suppressing turbulence in the air flowing over the bottom of the vehicle, while also ensuring that L is as short as possible, thereby ensuring the ground clearance that allows for good off-road performance. This ratio of H:L was derived through verification by the inventors.

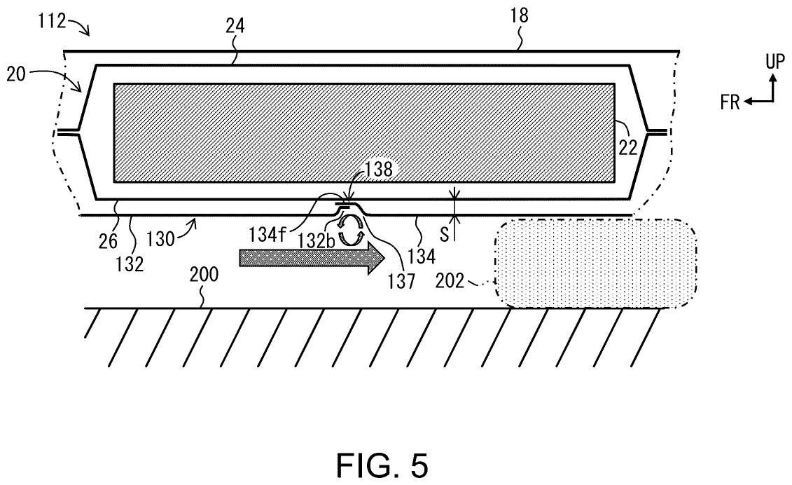

Here, comparative technology is explained. FIG. 5 is a cross-sectional view schematically showing comparative technology of a vehicle base structure. The vehicle base structure 112 (FIG. 5) has a different structure for the connection portion 138 of the under cover 130 than the vehicle base structure 12 (FIG. 1) described above.

Specifically, in the vehicle base structure 112 shown in FIG. 5, the rear end 132b of the front cover 132 is bent upwards and then horizontally toward the rear. Also, the front end 134f of the rear cover 134 is bent upwards and then horizontally toward the front. The connection portion 138 of the front cover 132 and the rear cover 134 is formed by the horizontal portion of the front end 134f of the rear cover 134 overlapping the horizontal portion of the rear end 132b of the front cover 132. The connection portion 138 has a recess 137.

With this comparative technology, when the vehicle is driving backward on the road with accumulated snow 202 and the accumulated snow 202 advances toward the connection portion 138, the recess 137 prevents the snow 202 from advancing to the end face of the rear end 132b of the front cover 132. As a result, it is possible to prevent the snow from entering the vehicle interior through the connection portion 138 (the overlapping portion).

Here, the advantages of the embodiment (FIG. 1) described above over the comparative technology (FIG. 5) is explained. In the comparative technology, when the vehicle is moving forward and air (see the bold arrow in FIG. 5) flows over the bottom of the vehicle, the flow of air is disturbed at the recess 137 (see the two opposing curved arrows in FIG. 5), which worsens the aerodynamic performance. On the other hand, according to the embodiment described above (FIG. 1), the structure has a protrusion 36 that can suppress the disturbance of air as described above, so it is possible to expect an improvement in the aerodynamic performance compared to the comparative technology. It is possible to expect an improvement in vehicle stability and fuel efficiency (or electric efficiency).

In addition, in the case of the comparative technology, as shown in FIG. 5, because the structure has the recess 137, the underside of the under cover 130 (the general surface) other than the recess 137 is at a relatively low position. In other words, the gap S between the lower case 26 of the battery 20 and the under cover 130 is relatively large. On the other hand, according to the embodiment described above, as shown in FIG. 1, because it has a structure with a protrusion 36, the position of the lower surface (general surface) of the under cover 30 other than the protrusion 36 can be made relatively high. In other words, the gap S between the lower case 26 of the battery 20 and the under cover 30 can be made relatively small.

The ability to reduce the gap S in the vehicle 10 is a significant advantage. In other words, the smaller the gap S, the more likely it is that at least one of the following (1) to (3) will be achieved.

(1) The ground clearance can be set to ensure that the vehicle can travel over obstacles (the ground clearance can be increased).

(2) The size of the battery 20 can be increased.

(3) The interior space can be increased (a lower floor can be achieved).

From the above, it can be understood that the vehicle base structure 12 (FIG. 1) has excellent action effects.

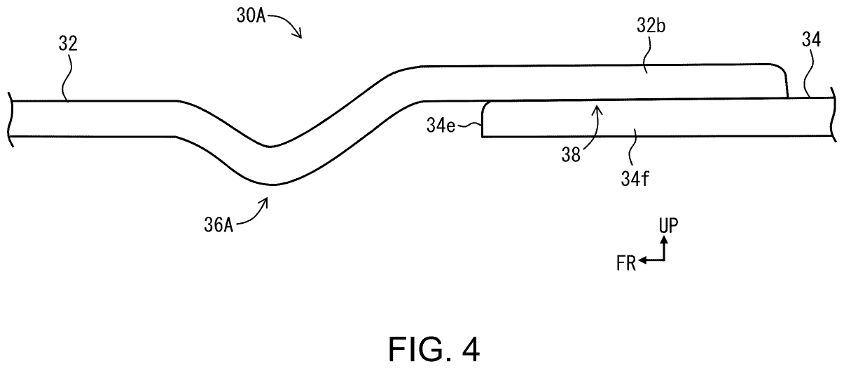

A modification of the present disclosure is explained. FIG. 4 is an enlarged cross-sectional view of a modification of a connection portion 38 of the front cover 32 and rear cover 34. FIG. 4 shows the portion corresponding to FIG. 3. In this modification, the structure of the connection portion 38 of the under cover 30A is different from the vehicle base structure 12 (FIG. 1) described above.

Specifically, in the connection portion 38 of this modification, the rear end 32b of the front cover 32 is located above the front end 34f of the rear cover 34. The front cover 32 has the protrusion 36A at a frontward position relative to the connection portion 38 (the overlapping portion) in the longitudinal direction of the vehicle.

In this modification, when the vehicle 10 is driving forward on the road with accumulated snow, the accumulated snow advances toward the end face 34e of the lower cover (the rear cover 34) of the connection portion 38 that appears on the bottom of the vehicle 10. In this situation, there is a risk that the snow will enter the vehicle interior via the connection portion 38 (the overlapping portion).

However, according to this modification, when the snow advances toward the end face 34e of the rear cover 34, the protrusion 36A pushes the snow down, and prevents the snow from advancing toward the end face 34e of the rear cover 34. As a result, it is possible to prevent the snow from entering the vehicle interior through the connection portion 38 between the two covers 32, 34.

In addition, according to this modification, the other effects (such as improved aerodynamic performance and reduced gap S) of the vehicle base structure 12 (FIG. 1) described above can also be obtained in the same way.

In the embodiment and the modification described above, the connection portion 38 of the front cover 32 and the rear cover 34 is formed by overlapping the rear end 32b of the front cover 32 and the front end 34f of the rear cover 34. The cover that is positioned above the connection portion 38, among the front cover 32 and the rear cover 34, has a protrusion 36 (36A) that protrudes downward from the vehicle and is located adjacent to the connection portion 38. With this configuration, as the vehicle moves, the accumulated snow moves toward the vehicle in a direction. The direction is from one of the front cover 32 and the rear cover 34 that is located above the other of them at the connection portion 38 to the other of them. At that time, the protrusion 36 (36A) pushes the snow down, and it is possible to prevent the snow from advancing to the end face of the lower cover that appears on the bottom of the vehicle. This prevents the snow from entering the vehicle through the overlap (the connection portion 38) of the two covers 32, 34.

In the embodiment and the modification described above, the under cover 30 (30A) is made of resin, but the under cover 30 (30A) may be made of other materials such as metal. In addition, the under cover 30 (30A) and the lower case 26 of the battery 20 may be joined by means other than the clips 42 (e.g., screws, bolts, rivets, etc.).

1. A vehicle base structure applicable to a vehicle with a battery mounted under a floor of the vehicle, the vehicle base structure comprising:
an under cover which is disposed below the battery and forms at least a portion of a bottom of the vehicle;
wherein the under cover includes a front cover and a rear cover disposed at a rearward position relative to the front cover in a longitudinal direction of the vehicle,
a connection portion is provided, the connection portion being an overlap between a rear end of the front cover and a front end of the rear cover, and
one of the front cover and the rear cover that is located above the other of the front cover and the rear cover at the connection portion has a protrusion protruding downward from the vehicle at a position adjacent to the connection portion.

2. The vehicle base structure according to claim 1, wherein
the front end of the rear cover is located above the rear end of the front cover in the connection portion, and
the rear cover has the protrusion at a rearward position relative to the connection portion in the longitudinal direction of the vehicle.

3. The vehicle base structure according to claim 2, wherein
a distance in the vertical direction of the vehicle from a bottom surface of the rear cover at a front end thereof to a bottom surface of the protrusion of the rear cover at an apex thereof is defined as a height of the protrusion,
a distance in the longitudinal direction of the vehicle from the apex of the protrusion of the rear cover to a rearward end of change in height of the bottom surface of the rear cover is defined as a return distance of the protrusion, and
the return distance of the protrusion is twice the height of the protrusion.

4. The vehicle base structure according to claim 1, wherein
the rear end of the front cover is located above the front end of the rear cover in the connection portion, and
the front cover has the protrusion at a frontward position relative to the connection portion in the longitudinal direction of the vehicle.
